(19) United States
(12) Patent Application Publication
(10) Pub. No.: US 2006/0271949 A1
(43) Pub. Date: Nov. 30, 2006

(54) METHOD AND APPARATUS FOR LIMITING ACCESS TO VIDEO COMMUNICATIONS

(75) Inventors: JACK PERRY, MARION, IA (US); KENNETH A. FRANKEN, IOWA CITY, IA (US); TOUFIC MOUBARAK, IOWA CITY, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(73) Assignee: DECISIONMARK CORP., CEDAR RAPIDS, IA (US)

(21) Appl. No.: 11/423,293

(22) Filed: Jun. 9, 2006

Related U.S. Application Data
(63) Continuation of application No. 09/681,845, filed on Jun. 15, 2001.
Application No. 09/681,845 is a continuation-in-part of application No. 09/538,215, filed on Mar. 30, 2000, now Pat. No. 6,252,547.
Application No. 09/538,215 is a continuation-in-part of application No. 09/092,128, filed on Jun. 5, 1998, now Pat. No. 6,147,642.

(51) Int. Cl. H04N 7/173; G01C 21/00; G06F 7/00; G06F 17/00; G06F 15/00; G05D 3/00; H04N 7/16; G05D 1/00

(52) U.S. Cl. 725/25; 725/112; 725/113; 715/501.1; 715/500.1; 701/1; 701/200

(57) ABSTRACT

An apparatus for controlling the reception of video programming as a function of a location associated with a prospective viewer. In one embodiment, a GPS receiver is utilized to control the delivery to the location. In another embodiment, a distributed approach is utilized which uses at least two separated servers in which one is used for inputting information relating to a location and another server is utilized for determining eligibility and either directly through a hardware connection or indirectly through a display terminal providing for manipulation of the satellite receiver and satellite transmitter combination so as to restrict access to signal reception by said satellite receiver at the location if a strength of a terrestrially broadcast television signal exceeds a predetermined threshold.

### CROSS-REFERENCES TO RELATED APPLICATIONS

This application is a continuation of application Ser. No. 09/681,845 entitled “SYSTEM AND METHOD OF GEOGRAPHIC AUTHORIZATION FOR TELEVISION AND RADIO PROGRAMMING DISTRIBUTED BY MULTIPLE DELIVERY MECHANISMS”, which was filed on Jun. 15, 2001, which is a continuation-in-part of application Ser. No. 09/538,215 entitled “METHOD AND APPARATUS FOR LIMITING ACCESS TO SIGNALS DELIVERED VIA THE INTERNET” filed on Mar. 30, 2000, which issued as U.S. Pat. No. 6,252,547 on Jun. 21, 2001, which is a continuation-in-part of application Ser. No. 09/092,128 entitled “METHOD AND APPARATUS FOR LIMITING ACCESS TO INTERNET COMMUNICATION SIGNALS” filed on Jun. 5, 1998, and issued as U.S. Pat. No. 6,147,642 on Nov. 14, 2000, all of which are incorporated herein in their entirety by this reference.

### FIELD OF THE INVENTION

The present invention relates to communication, and more particularly relates to regulation of access to communication signals via electronic means.

### BACKGROUND OF THE INVENTION

In the past, network television signals were only receivable by viewers receiving signals broadcast from terrestrial transmitters at distributed network affiliate stations. As a result, in years past, many remote and rural areas of the U.S. had either no, or very limited access to network television service. With the advent of satellite communications, many of these remote viewers are now able to receive network programming; however, many of the networks would like to restrict the availability of these signals to only those customers in locations which are unable to receive signals broadcast from network affiliate stations. The difficulty in meeting the networks' desires is increased by the fact that today, more and more homes and business are located in remote areas and further, by the use of television satellite receivers on recreational vehicles which are able to move in and out of remote areas.

Consequently, there exists a need for improved methods and apparatuses for determining and regulating the availability of access to satellite communication signals.

Also, it has been rapidly becoming more commercially feasible to provide broadcast television to consumers in real time via the Internet. Increasing bandwidth and advances in video compression technology make it technologically possible to stream VCR quality video to consumers today. Soon it is expected that nearly all Americans will have the technology which could be made to receive television via the Internet.

While Internet delivery of television programming has been done in the past, it does have some drawbacks. The most salient of these drawbacks is that Internet delivery of broadcast television programming is alleged to be in violation of the U.S. copyright laws. American television is based on the network-affiliate distribution system. In essence, the networks typically supply general-interest programming, and their local affiliates supplement this with local-interest programming and syndicated content. A mix of local and national advertising sales often finds the system. The system has worked well for many years. Localism and local origination of programming have been central features of the system of regulation broadcast television in this country.

Fundamental to this model is the territorial exclusivity granted to the local affiliates. Prior to cable TV, territorial exclusivity was enforced via FCC transmitter licensing. With the advent of new delivery mechanisms for television, Congress has given cable and satellite TV services permission to retransmit broadcast TV channels under a compulsory license; but those rights limit retransmissions to a specific geographic area to prevent broadcasts from one city from “eating” into the audience of programs in another. Cable carriage rules are largely designed to replicate broadcast television signal areas.

Television delivery via the Internet as it currently exists, with its global-free access characteristics, challenges these well-established territorial restrictions.

Similarly, radio shares much of the same territorial broadcast exclusivity of television.

Consequently, there exists a need for improved methods and systems for delivery of television and radio programming via the Internet.

### SUMMARY OF THE INVENTION

It is an object of the present invention to provide enhanced abilities to quickly and easily regulate access to satellite communication signals.

It is a feature of the present invention to include an apparatus for determining a geographic reference point for a particular satellite customer.

It is an advantage of the present invention to achieve a more accurate assessment of the quality of terrestrial broadcast signals at a particular location.

It is another object of the present invention to provide a real time determination of access to satellite communication signals.

It is another feature of the present invention to include a geographic reference point for a particular location.

It is another feature of the present invention to include a GPS receiver for generating geographic reference points for a mobile satellite receiver.

It is another object of the present invention to provide low-cost determination of the availability of access to satellite communication signals.

It is yet another feature of the present invention to include a distributed processing system.

It is another advantage of the present invention to reduce cost by using existing computing resources and a central location for application specific resources.

It is another object of the present invention to provide wide accessibility to resources for determining access to satellite communication signals.

It is another feature of the invention to utilize computer networks, such as the Internet, for interconnecting several components of a distributed system.

The present invention is a method and apparatus for determining and regulating the access to satellite communication signals based upon a determination of a geographic position for a potential satellite signal receiver, which is designed to satisfy the aforementioned needs, provide the previously stated objects, include the above-listed features and achieve the already articulated advantages. In the present invention the time required, the difficulty and the expense associated with accurately regulating access to satellite communication signals has been reduced.

Accordingly, the present invention is a method and apparatus for determining and regulating access to satellite communication signals by reference to a geographic determination of the location of a potential satellite receiver and a generation of a signal representative of a signal strength of terrestrially broadcast television signals at a particular location.

Also, with respect to one embodiment:

It is an object of the present invention to provide a system and method for delivering television and radio programming via the Internet.

It is a feature of the present invention to utilize a viewer/listener authorization scheme which authorizes delivery of broadcasts to those geographic locations which meet certain predetermined criteria.

It is another feature of the present invention to include signal strength prediction technology to calculate the availability of broadcast signals, via an antenna at a particular declared location.

It is yet another feature of the present invention to include a programmable Internet viewer authorization scheme which includes a variable business rule scheme for using geographic limitations in authorizing access to television and radio broadcast via the Internet.

It is an advantage of the present invention to achieve geographically limited authorization of television and radio programming via the Internet.

Also, the present invention is an apparatus and method for authorizing Internet delivery of television/radio programming which is designed to satisfy the aforementioned needs, provide the previously stated objects, include the above-listed features, and achieve the already articulated advantages. The present invention is carried out in a non-global consuming area manner in a sense that the geographic viewing/listening area of television programming is authorized only to limited consumers located in positions which are computed to have a predetermined relationship with a predetermined criteria for viewer/listener authorization.

Accordingly, the present invention is a system and method including an Internet viewer/listener location authorization scheme which provides a limited authorization of viewers based upon their geographic location with respect to predetermined authorization limitations.

### BRIEF DESCRIPTION OF THE DRAWINGS

The invention may be more fully understood by reading the following description of the preferred embodiments of the invention, in conjunction with the appended drawings wherein:

FIG. 1 is a block diagram of the major functional components of a system of the present invention.

FIG. 2 is a block diagram of the major functional components of a system of the present invention in which the dashed lines encircle portions of the system coupled to the satellite receiver.

FIG. 3 is a block diagram of the major functional components of a system of the present invention in which the dashed lines encircle portions of the system located at a satellite signal control station.

FIG. 4 is a block diagram of the major functional components of a system of the present invention in which the dashed lines encircle portions of the system located at a satellite signal control station.

FIG. 5 is a block diagram of the major functional components of a system of the present invention in which the dashed lines encircle portions of the system implemented on a single server, and the dotted and dashed line represents portions of the system implemented on a separate server.

FIG. 6 is a block diagram of the major functional components of a television/radio programming delivery authorization system of the present invention.

### DETAILED DESCRIPTION OF THE DRAWINGS

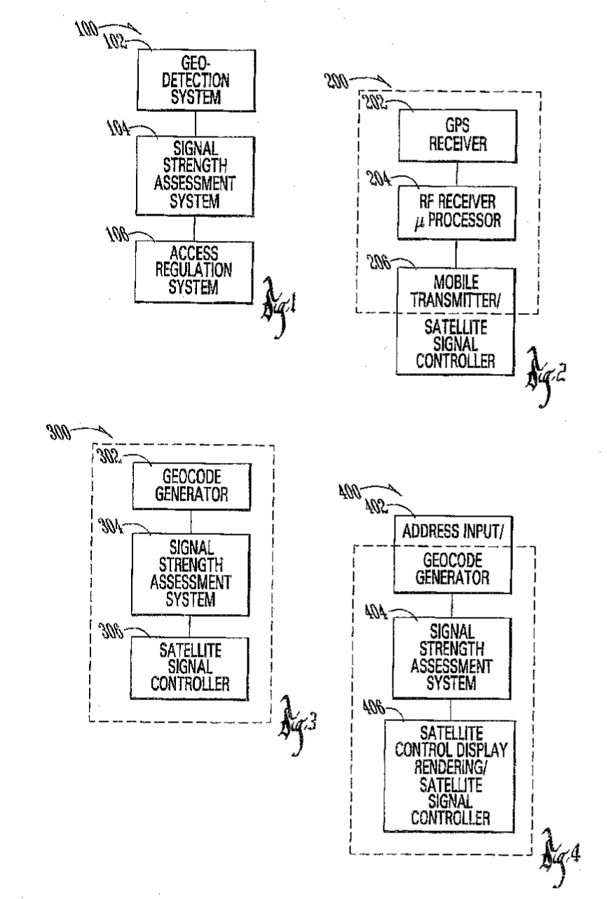

Now referring to the drawings, wherein like numerals refer to like matter throughout, and more specifically to FIG. 1, there is shown a satellite communication regulating system of the present invention generally designated 100, having a geo-detection system 102, a signal strength assessment system 104 and an access regulating system 106.

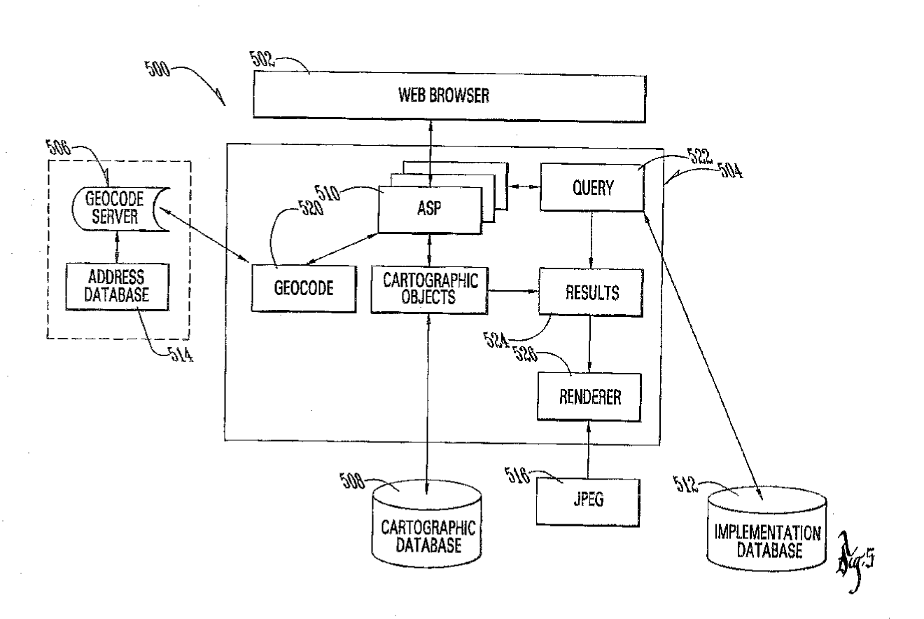

In various embodiments of the present invention, the functions of systems 102, 104 and 106 have varying levels of physical distribution. For example, in systems for real time regulation of mobile satellite receivers (see FIG. 2 and accompanying text), all systems may be co-located with the mobile satellite receiver. The expense of this approach may be unnecessary for other less mobile needs. For example, in another potential embodiment, the majority of the system can be performed by one personal computer with specially designed software. In yet another embodiment, use can be made of existing software, such as web browsers, and portions of the system's functions can be distributed to end users operating personal computers not dedicated solely to the task of regulating access to a satellite communication system (see FIG. 3 and accompanying text). While the process can be further distributed to various clients and a central server (see FIG. 4 and accompanying text).

Now referring to FIG. 2, there is shown an apparatus of the present invention generally designated 200, having a GPS receiver 202 which essentially performs the function of block 102 of FIG. 1. The dotted line in FIG. 2 encircles the components of the present invention which are co-located with a mobile satellite receiver. The GPS receiver determines the location of the mobile satellite receiver and generates a geocode or lat-long reference signal corresponding to the current location of the mobile satellite receiver. This signal is provided to RF receiver/microprocessor 204. The microprocessor is used to tune the frequencies of local network television affiliates in the vicinity of the location determined by the GPS receiver. The RF receiver determines the signal strength of the received signals and the microprocessor compares the signal strengths to a predetermined threshold. Based upon the results of the comparison, a determination of access to network satellite signals is made. Coupled to RF receiver/microprocessor 204 is mobile transmitter/satellite signal controller 206. Block 206 includes a mobile transmitter which transmits the results of the comparison of the signal strengths to a predetermined threshold to a remote location in which the satellite signal controller is located. The satellite signal controller is well known in the art of generation and control of satellite signals and is used to permit and/or restrict access to network television signals broadcast from a satellite by including an ID code which enables remote satellite receivers to fully utilize the satellite signals. These satellite signal controllers are currently in use and well known in the art.

Now referring to FIG. 3, there is shown an embodiment of the present invention generally designated 300 having a geocode generator 302, a signal strength assessment system 304 coupled thereto and a satellite signal controller 306. The entire blocks 302, 304 and 306 are shown to be enclosed within the dashed line of FIG. 3 thereby representing that all of these functional blocks are co-located and are topically disposed or coupled to the well-known apparatus for uplinking information to communication satellites. The entire system 300 could be performed on a single computer, such as a personal computer. The geocode generator would include an input/output capability in which an operator could input an address of a residence or business which utilizes a satellite receiver. The operator could enter the address and known geocode generators could generate latitude and longitude signals in response to the input address. This latitude/longitude determination would be used as an input in the signal strength assessment system in which local network television affiliates are identified in the vicinity of the lat-long reference generated by the geocode generator and a calculation of the signal strength of each of the local network affiliates can be calculated at each position determined by the geocode generator. If the signal strength falls below a predetermined threshold, then an access enabling determination is forwarded from Block 304 to Blocks 306. Block 306 would be the satellite's signal controller which would then generate an appropriate access code for transmission to the remote satellite receiver, thereby enabling reception of the network transmission. The benefits of the system 300 are that it can provide the ability to generate and regulate access to network transmissions in a cost effective manner. The obvious downside of system 300 in comparison to system 200 is that it is located at a fixed site and it does not allow for real time adjustment of the access to the network signals. Additionally, system 300 is limited to allowing access of input at one location.

Now referring to FIG. 4, there is shown a system of the present invention, generally designated 400, having an address input/geocode generation block 402 coupled to a signal strength assessment system 404 which is coupled to a satellite controlled display rendering system/satellite signal controller 406. The system 400 allows for a more distributed approach than does system 300, and the matter encircled by the dashed line in FIG. 4 represents the portions of the system which could be co-located. The address input component of Block 402 could be distributed to various users dispersed geographically, thereby allowing for increased use and access to the system 400. The address input function of Block 402 could be performed by common hardware and software in an effort to reduce the overall cost of implementing system 400. For example, the address input component of Block 402 could be performed by numerous personal computers using well known web browsers. The information could be input at various locations and transmitted over the Internet to a central location where the geocode generation component of Block 402 could transform the street address to a latitude and longitude. This latitude and longitude then could be utilized by signal strength assessment system 404 to make a determination of the signal strength of various local network television affiliates in the vicinity of the address input by the operator.

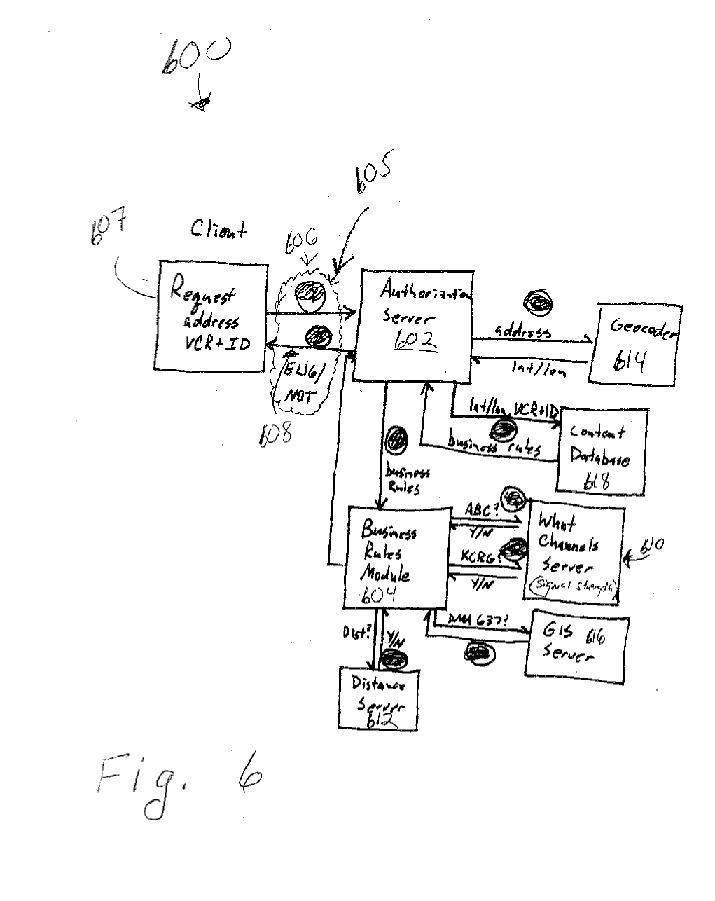

Now referring to FIG. 5, there is shown a system of the present invention generally designated 500 which provides for widely distributed processing capability, which includes at least one Web browser 502 disposed at a first location and on a first computer. This computer may be a typical IBM compatible computer operating on a Windows environment or any other computer capable of operating a Web browser or subsets of a Web browser. The Web browser 502 is coupled via a computer network to a satellite signal control server 504 located at a second location which is designated by the intermittent line and preferably is located on a single server and operates on industry standard Web server software such as Microsoft Internet Information Server (IIS) Version 3.0 or later. Server 504 hosts several Active Server Pages (ASPs) which contains scripts of actions to perform and programmatic steps to generate Hyper Text Markup Language (HTML) to be provided back to Web browser 502. Server 504 provides a novel mechanism for producing complex interaction without requiring sophisticated browser technology such as client side Java Applets or dynamic HTML (DHTML) on Web browser 502. Active Server Pages 510 may, but need not contain embedded therein scripts such as Visual Basic script (VB script) or Microsoft's dialect of JavaScript. The ASP 510 may be able to use any standard component that runs with an NT server environment, such as Microsoft-defined interfacing standard Component Object Model (COM). This enables designers to very early tailor the present invention to meet particular user requirements. All that a designer need do is customize the ASP 510 without the need for other changes to result in a customized interface with browser 502.

Coupled to server 504 is geocode server 506 which may be a separate process providing geocoding services. This geocode server may be any commercially available geocoder such as geocoders provided by QMS, Group 1 and MatchWare, all of which are known in the art, or in other implementation. The function of geocode server 506 could be provided by a GPS receiver. In a preferred embodiment, the geocode server 506 might be configured such that a “wrapping” or geocoding interface is interposed between the commercially available geocoders (QMS, Group 1, MatchWare, etc.) or a GPS receiver, so as to provide a uniform interface with the remainder of system 500. However, it is believed that in some instances, it may be preferable to operate servers 504 and 506 on independent computers. Server 504 is shown coupled to Cartographic database 508 and Implementation database 512. These may be standard Structured Query Language (SQL) databases which contain cartographic data and data specific to a particular implementation of the present invention. In one embodiment of the present invention, the implementation database 512 would contain information about specific television stations, including their DMA, call sign, network affiliation, and signal area map. It should be understood that in other applications, the databases would not contain television signal related information and would be tailored to include other information which is dependent upon and associated with certain predetermined locations. The cartographic database 508 may contain background cartography, such as state and county boundaries, interstate highways, and coastal water. These databases are preferably SQL databases that the Web server 504 accesses using standard Open Database Connectivity (ODBC) drivers. The present invention need not specify any particular database or database server platform, a candidate database need only provide an ODBC driver and be capable of storing SQL Binary Logic Objects (BLOBs). The preferred embodiment of the present invention uses Microsoft SQL servers running on an independent machine from the IIS server 504.

All databases 508, 512, and address database 514 of geocode server 506 may contain cartographic data which conforms to the Puckett database format. This format provides for standard encoding of cartographic shape data, and for storing that data directly within a standard SQL database.

Web server 504 may generate a geographical map 516 upon a request from a client operating Web browser 502. The map representation 516 may be in any industry standard graphics format, such as JPEG, PNG, GIF, or any suitable form at.

The present invention may be more fully understood by reviewing its operation. In operation, the present invention performs as follows:

A user inputs a URL for a particular ASP of the server 504 into Web browser 502. Server 504 contains the active server page and generates and delivers a page with HTML to Web browser 502. The user enters a street address into Web browser 502 and transmits the same to server 504 which, with the aid of geocode function 520, identifies the need for geocoding the address and communicates the street address to geocode server 506, which accesses address database 514 and develops a latitude and longitude reference for the street address and provides the same back to geocode function 520. Query function 522 is called by ASP 510 to request a list of stations which match the given latitude and longitude coordinates in a particular DMA. The query object 522 makes a database query of implementation database 512 and calls the point-in-polygon function provided by the Puckett cartographic object library or other mechanism such as the signal strength assessor. The Query object 522 then generates a results object 524 to contain information about the identified relevant television stations.

In a second phase, the Active Server Page 510 goes through the information contained in the results object 524 and then emits an HTML table page that describes the relevant stations. This table may contain HTML code for hyperlinks that a client or user operating Web browser 502 may select to view a map or other related information.

In a third phase, the user of browser 502 selects a hyperlink for a map which is transmitted back to ASP 510 which submits a request to the results object 524 to emit a map in a browser supported graphics format such as PNG or JPEG map 516. The results object 524 first creates a multi-layer map using the Puckett cartographic object library. The results object next uses the standard Puckett map rendering component to draw the map. The renderer 526 uses the standard cartographic object library as it draws.

Consequently, a user of Web browser 502 is able to determine a signal strength characteristic of a particular television station at a known street address through the use of the invention 500. In general, the user of Web browser 502 may be given information relating to the signal strength of a particular terrestrially broadcast television station at a particular location and whether or not that signal strength exceeds a predetermined threshold characteristic. The user of Web browser 502 may desire additional information relating to the signal strength and may request via Web browser 502 that a map in a format that is supported by the browser be generated. This map may show the geographic area in which the signal strength is believed to be in excess of a predetermined threshold. The user of Web browser 502 then may directly or indirectly manipulate a combination of a satellite receiver and a satellite transmitter in response to the signal strength signal so as to permit or deny access to a predetermined satellite signal based upon a comparison of a signal strength of the terrestrially broadcast television signal with a predetermined threshold. A designer may choose to use well-known devices such as Puckett point-in-polygon testers and Longley-Rice signal strength calculators.

Throughout this description references are made to “satellite receivers”. It is intended that the present invention could also include internet receivers, which term shall include any appliance for receiving and either visually displaying information or producing an audible sound, as a result of receiving signals via the internet. This could include, but need not be limited to, personal computers, e-machines, internet appliances, etc. Throughout this description, references are made to “television signals” and “television communication”. It should be understood that these terms should include signals relating to radio, as well as those relating to television. Throughout his description, references are made to “satellite signal controller”. “satellite control display rendering”, and “access regulation system”. It should be understood that these terms could also include internet signal controllers, internet control display rendering, and as internet access regulation system, which terms should be understood to include any means to regulate access to signals or sites on the internet, including, but not limited to, passwords, cookies, electronic signatures, electronic keys, encryption, and any other access regulating device used with respect to internet communications. The details of any particular access restricting system, device, or scheme are not given here because the present invention is intended to include any type of access restricting system in the prior art as well as future modifications of or substitute for such access restricting systems, devices, or schemes.

Now referring to FIG. 6, there is shown a television/radio programming delivery authorization system of the present invention generally designated 600, having an authorization server 602 and a client 607, both of which could be a personal computer or any type of general purpose computer. Authorization server 602 preferably will have a collection of business rules algorithms 604 therein or coupled thereto, or making authorization determinations based upon various criteria, including signal strength and other than signal strength. Authorization server 602 accepts a geographic location and programming request input 606, such as a street address, lat-lon, zip code, or other geographic reference from client 607, via a computer network 605, such as the Internet. Location specific authorized content list and/or individual programming eligibility determination indicator 608 is the result of operation of authorization server 602. In other words, for each geographic location and programming request input 606 provided as an input, the output is a single eligibility determination or a list of programming which is authorized to be received at that location, via various means of delivery. For example, satellite distribution of network television signals are authorized based upon the signal strength of local network affiliates serving the location. This notion of using signal strength as a criteria for authorization of satellite signals is depicted by What Channels Server 610. The above-referenced patent entitled “METHOD AND APPARATUS FOR LIMITING ACCESS TO INTERNET COMMUNICATION SIGNALS” filed on Jun. 5, 1998, and now issued as U.S. Pat. No. 6,147,642 describes in detail the function of signal strength calculators in What Channels Server 610. What Channels Server 610 could be used to authorize distribution of television or radio signals via distribution means other than satellite. For example, What Channels Server 610 could be used to authorize distribution of such signals via the Internet based upon signal strength. Details of using signal strength to authorized Internet delivery of television programming is described in the above-referenced patent application entitled; “METHOD AND APPARATUS FOR LIMITING ACCESS TO SIGNALS DELIVERED VIA THE INTERNET” having Ser. No. 09/538,215 filed on Mar. 30, 2000, and now issued as U.S. Pat. No. 6,252,547. The present invention is an expansion of these two ideas in that it applies to distribution means other than satellite and internet-delivered programming other than that based solely upon signal strength calculations. The present invention also includes means for authorization of programming delivery over any type of distribution system based upon other non-signal strength criteria such as by using a distance from a point calculator 612, and a Geographic Information System (GIS) boundary computer 616. In any embodiment, it is preferred to include a programming content and business rule database 618 which includes, among other things, a listing of all of the programming content available irrespective of location and means of distribution.

The present invention functions as follows:

Client 607 sends a geographic location and programming request input 606, which is preferably a VCRPlus ID and street address. The VCRPlus ID is assumed to encode information which uniquely identifies the content, the content provider and the content delivery mechanism. VCRPlus is well known in the art and is believed to be readily adaptable to include the above-listed information. VCRPlus is a registered trademark owned by Gemstar Development Corp. of Pasadena, Calif., USA. The client 607 is assumed to have previously validated that the street address provided in the geographic location and programming request input 606 is indeed the location where the programming will be delivered. In an alternate arrangement, another server other than the client 607 could be used to perform the validation. Authorization server 602 will provide the street address in geographic location and programming request input 606 to the location database/geocoder 614, which will return a lat/lon to authorization server 602. Of course, if lat/lon is originally provided in geographic location and programming request input 606 by the client 607, this step is unnecessary. The authorization server 602 then queries the programming content and business rule database 618 for business rules which would be applicable to the geographic location and programming request input 606 (the VCRPlus ID and lat/lon). For the purpose of example, it will be assumed that geographic location and programming request input 606 relate to a request for programming which is on the ABC network and provided by local affiliate KCRG, in Cedar Rapids, Iowa, and will be delivered via the Internet. The rules which could be returned by programming content and business rule database 618 could be as follows:

a) content can be delivered via the internet into households where all ABC network signals predicted for the lat/lon returned by location database/geocoder 614 are predicted to be below Grade B by What Channels Server 610. “Grade B” is a term of art which is well known and used in the determination of eligibility for delivery of network programming via satellite.

b) content can be delivered via the internet into households where the predicted signal strength of local affiliate KCRG is at least Grade B at the lat/lon provided by location database/geocoder 614.

c) content can be delivered into households inside DMA 637 (the DMA serviced by KCRG TV and including Cedar Rapids, Iowa, and surrounding areas).

The business rules algorithms 604 could process the above-listed business rules as follows:

1) for rule a), query the What Channels Server 610 for all ABC stations serving the location with a Grade B or better signal. If the query return is empty, then the request is eligible and the process is stopped.

2) for rule b), query the What Channels Server 610 for the KCRG signal at the location. If the signal is predicted to be at least Grade B, then the request is eligible and the process is stopped. (Note: it may be more practical to combine these first two steps.)

3) for rule c), query the GIS boundary computer 616 for an answer to the question: “Is the location inside of DMA 637?” If the query result is “Yes”, then the request is eligible and the process is stopped. (Note: If the original programming request in geographic location and programming request input 606 were for something different, such as an NFL game in an NFL home city, then the programming content and business rule database 618 may have returned business rules which are not related to signal strength, but to distance from the stadium. In such cases, the distance from a point calculator 612 would be used instead of a signal strength calculator in the What Channels Server 610.)

4) If steps 1-3 do not produce an eligibility determination of “Yes”, then the process is stopped and an “Ineligible” indication is provided in Location specific authorized content list and/or individual programming eligibility determination indicator 608. (Note: the entire process can be repeated for other content request from the location, thereby creating a location specific authorized content list.)

It is believed that various details may be different in the software code used to implement distance from a point calculator 612, location database/geocoder 614 and GIS boundary computer 616, but with the guidance provided by this description, a person skilled in the art could readily construct an authorization system as described and claimed herein which is tailored to the particular needs of any specific application. It is also believed that the number and details of the business rules in programming content and business rule database 618 will vary from application to application and will vary within a single application over time.

The present invention is intended to cover all such applications which a person skilled in the art might implement, with the aid and assistance of the description herein.

It is thought that the method and apparatus of the present invention will be understood from the foregoing description and that it will be understood from the foregoing description that it will be apparent that various changes may be made in the form, construction, steps and arrangement of the parts and steps thereof, without departing from the spirit and scope of the invention or sacrificing all of their material advantages. The form herein described being merely a preferred or exemplary embodiment thereof.

We claim:

1. An apparatus for regulating access to video programming comprising:
means for determining a geographic reference point for a particular location, and generating a location reference in response thereto;
software means, responsive to said location reference and further responsive to an internet-delivered individual viewer location and responsive to a request for programming, for making a determination of eligibility to receive video programming; and
means for selectively permitting delivery of video programming in response to said determination of eligibility.

2. An apparatus of claim 1 wherein said means for determining a geographic reference point comprises a GPS receiver.

3. An apparatus of claim 1 wherein said means for determining a geographic reference point comprises a web browser.

4. An apparatus of claim 1 wherein said means for determining a geographic reference point comprises a geocoding server which takes street addresses and generates corresponding latitude and longitude coordinates.

5. An apparatus of claim 1 wherein said software means, responsive to said location references utilizes a result of a point-in-polygon tester, thereby comparing a location reference to a geographic exclusion area.

6. The apparatus of claim 5 wherein the geographic exclusion area is a reception area of a terrestrially broadcast signal.

7. A method for delivery of video programming over a wide area comprising the steps of:
receiving a specific request for video programming which was generated for a prospective viewer;
associating a specific geographic location with the specific request;
using the specific geographic location as an input into a predetermined computer software algorithm;
computing a video programming access determination for the prospective viewer using the predetermined computer software algorithm; and
causing delivery of the video programming to the prospective viewer in response to the video programming access determination.

8. The method of claim 7 further comprising the step of providing location information via an internet connection.

9. The method of claim 7 wherein the step of associating a specific geographic location with the specific request comprises the step of determining a location of a viewer.

10. The method of claim 9 wherein the step of using the specific geographic location as an input into a predetermined computer software algorithm further comprises the steps of inputting the location of the viewer into a signal strength prediction formula.

11. The method of claim 7 wherein the step of causing delivery of the video programming to the prospective viewer in response to the video programming access determination further comprises the steps of selectively enabling a satellite receiver.

12. A method of regulating access to video programming comprising:
determining geographic reference information for a particular potential video viewer;
generating an eligibility determination by comparing a number based at least in part upon the geographic reference information, with a predetermined number; and
enabling delivery of a predetermined video programming in response to said eligibility determination.

13. A method of claim 12 wherein said step of generating an eligibility determination by comparing a number comprises determining if a location is within a predetermined polygon.

14. A method of claim 13 wherein said determining geographic reference information utilizes a geocode server and said step of generating an eligibility determination utilizes a point-in-polygon tester.

15. A method of claim 12 wherein said step of determining geographic reference information is responsive to receipt of an internet-delivered location of a prospective viewer.

16. A method of regulating video programming comprising the steps of:
receiving, via an internet delivery details of a prospective viewer location and generating a geographic reference having a predetermined format in response thereto;
determining a video programming reception eligibility in response to said geographic reference; and
generating in response to said step of determining a video programming reception eligibility information enabling delivery of video programming to said prospective viewer.

17. An apparatus comprising:
means for receiving an address of a location and generating a geographic reference having a predetermined format in response thereto;
means for determining a video programming reception eligibility in response to said geographic reference; and
means for generating in response to an output of said means for determining a video programming reception eligibility information enabling delivery of video programming.

18. An apparatus of claim 17 wherein said means for receiving an address and generating a geographic reference signal is a first computer utilizing a Web browser to communicate with a coupled second computer utilizing a geocode server.

19. An apparatus of claim 18 wherein said address is street address.

20. An apparatus of claim 18 wherein said means for determining is a third computer coupled to said second computer.

21. An apparatus of claim 20 further including a display device for displaying information relating to said information.

22. A video programming control apparatus comprising:
means at a first location for receiving, via internet delivery, information relating to location details of a second location;
geocoding means for generating a reference corresponding to said details for said second location;
a processor-based means, coupled to said first location via a computer network, said processor-based means for generating a video reception eligibility determination;
said processor-based means for generating further for selectively enabling delivery of video programming based upon said video reception eligibility determination.

23. A system for selective delivery of video programming comprising:
a first processor at a first location, which transmits address specific information, via an internet connection, regarding a location of a prospective viewer;
a second processor, at a second location, coupled to and in communication with the first processor;
the second processor configured to receive the address specific information from the first processor regarding said location of a prospective viewer; and
the second processor further configured with software to selectively enable electronic delivery of video programming to the location of the prospective viewer, after an eligibility determination is made based upon the location of the prospective viewer.
